(19) United States
(12) Patent Application Publication
(10) Pub. No.: US 2025/0053346 A1
(43) Pub. Date: Feb. 13, 2025

(54) EFFICIENT INGEST TIER REFERENCES VIA VIRTUAL ADDRESSES

(71) Applicant: Dell Products L.P., Round Rock, TX (US)

(72) Inventor: Max Laier, Seattle, WA (US)

(21) Appl. No.: 18/366,275

(22) Filed: Aug. 7, 2023

(51) Int. Cl. G06F 3/06

(52) U.S. Cl. CPC G06F 3/0665; G06F 3/0604; G06F 3/0655; G06F 3/0673

(57) ABSTRACT

A method for efficient ingest tier references via virtual addresses includes generating, by a system including a processor, an address redirector for a data block in response to the data block being written to a first storage location, the address redirector including a reference to the first storage location. The method also includes writing, by the system, data including the data block to a second storage location in response to an amount of the data to be written to the second storage location being determined to be at least a threshold amount. The method further includes altering, by the system in response to the writing of the data to the second storage location, the address redirector to include a reference to the second storage location.

### BACKGROUND

In computing systems where the underlying data storage only allows for efficient writes of a given (typically large) size, multiple smaller writes can be coalesced into a larger chunk. Additionally, if a writing application requires that individual writes are stable, the smaller writes can be saved in a temporary location. As a result, data corresponding to a file and/or other data object can in some cases be present on both the underlying storage and the temporary location.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include a memory that stores executable components and a processor that executes the executable components stored in the memory. The executable components can include a data ingest component that writes file data to a first data storage location. The executable components can further include an addressing component that stores an address redirector for a block of the file data, the address redirector referencing the first data storage location. The executable components can additionally include a bulk write component that, in response to an amount of write data, comprising the file data, being determined to be at least a threshold amount, writes the write data to a second data storage location that is not the first data storage location. The addressing component can alter the address redirector to reference the second data storage location in response to the bulk write component writing the write data to the second data storage location.

In another implementation, a method is described herein. The method can include generating, by a system including a processor, an address redirector for a data block in response to the data block being written to a first storage location, the address redirector including a reference to the first storage location. The method can also include writing, by the system, data including the data block to a second storage location in response to an amount of the data to be written to the second storage location being determined to be at least a threshold amount. The method can further include altering, by the system in response to the writing of the data to the second storage location, the address redirector to include a reference to the second storage location.

In an additional implementation, a non-transitory machine-readable medium is described herein that can include instructions that, when executed by a processor, facilitate performance of operations. The operations can include allocating a virtual address for a data block corresponding to a file in response to recording the data block to a first location, where the virtual address references the first location; in response to an amount of data, including the data block, recorded to the first location being determined to be at least a threshold amount, writing the data to a second location that is not the first location; and, in response to the writing of the data to the second location, altering the virtual address to reference the second location.

### DESCRIPTION OF DRAWINGS

Various non-limiting embodiments of the subject disclosure are described with reference to the following figures, wherein like reference numerals refer to like parts throughout unless otherwise specified.

FIGS. 1-3 are block diagrams illustrating respective systems that facilitate efficient ingest tier references via virtual addresses in accordance with various implementations described herein.

FIG. 4 is a diagram depicting addressing operations that can be performed by a computing system in accordance with various implementations described herein.

FIG. 5-6 are block diagrams illustrating respective additional systems that facilitate efficient ingest tier references via virtual addresses in accordance with various implementations described herein.

FIG. 7 is a diagram depicting an example transfer of data from an ingest storage tier to a bulk storage tier in accordance with various implementations described herein.

FIG. 8 is a flow diagram of a method that facilitates efficient ingest tier references via virtual addresses in accordance with various implementations described herein.

FIG. 9 is a flow diagram depicting respective operations for efficient ingest tier references via virtual addresses that can performed by a processor in accordance with various implementations described herein.

FIG. 10 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

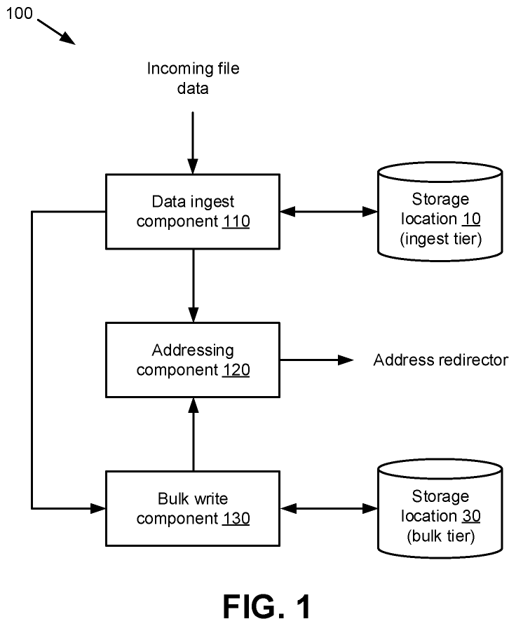

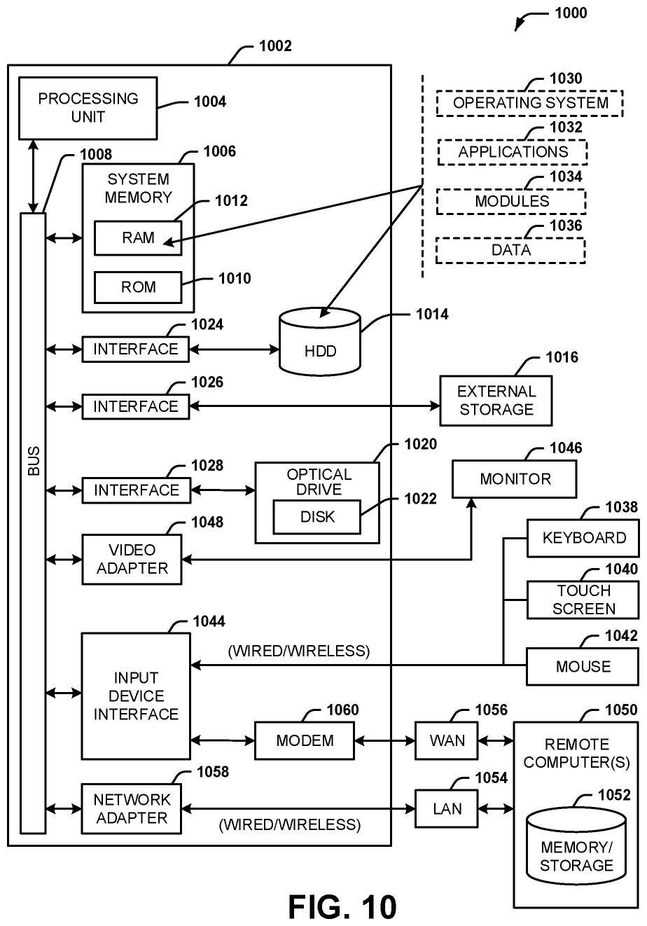

With reference now to the drawings, FIG. 1 illustrates a block diagram of a system 100 that facilitates efficient ingest tier references via virtual addresses in accordance with various implementations described herein. System 100 as shown in FIG. 1 includes a data ingest component 110, an addressing component 120, and a bulk write component 130, each of which can operate as described in further detail below. In an implementation, the components 110, 120, 130 of system 100 can be implemented in hardware, software, or a combination of hardware and software. By way of example, the components 110, 120, 130 can be implemented as computer-executable components, e.g., components stored on a memory and executed by a processor. An example of a computer architecture including a processor and a memory that can be used to implement the components 110, 120, 130, as well as other components as will be described herein, is shown and described in further detail below with respect to FIG. 10.

Additionally, it is noted that the functionality of the respective components shown and described herein can be implemented via a single computing device, e.g., a node device operating in a computing cluster and/or another suitable computing device, and/or a combination of devices. For instance, in various implementations, the data ingest component 110 shown in FIG. 1 could be implemented via a first device, the addressing component 120 could be implemented via the first device or a second device, and the bulk write component 130 could be implemented via the first device, the second device, or a third device. Also or alternatively, the functionality of a single component could be divided among multiple devices in some implementations.

Various implementations described herein are described with reference to a data storage system, e.g., a network attached storage (NAS) system and/or other computing system tasked with storing and/or managing client data. It is noted, however, that similar concepts to those described herein could be applied to any computing system that stores or manages data of any type and/or for any purpose. It is further noted that the following description and the claimed subject matter are not intended to be limited to any specific computing system implementation unless explicitly stated otherwise.

As stated above, some computing systems are configured such that efficient writes are only possible above a threshold size. This can occur, for example, in systems that utilize platter drives for data storage that can only be written to in a sequential pattern due to physical overlap of data on the drive platter and/or other considerations. As another example, it can be desirable in systems that utilize erasure coding for data to accumulate a full stripe before performing a write to enable complete calculation of the erasure codes for the stripe prior to writing.

Depending on the stripe size of the media to which writes are to be performed, a desired protection level for written data, and/or other factors, the threshold size for a sequential write can potentially be large, e.g., from approximately 2 megabytes to approximately 40 megabytes or larger. Accordingly, smaller writes can be accumulated at a temporary storage location, referred to herein as ingest media, until the threshold size is reached, at which time the accumulated write data can be flushed to permanent storage.

Conventionally, it has been difficult to record references to data in a temporary storage location as described above. These difficulties, in turn, can introduce significant complexity and inefficiency into the process of flushing data from temporary to permanent storage. To the furtherance of this and/or related ends, various implementations described herein can utilize virtual addresses, or other address redirectors, to record a write into the affected file in real time. The virtual address can then later be remapped following a flush operation. By utilizing virtual addresses in this manner, the system can avoid interacting with an affected file during a flush, thereby completely decoupling insert and flush processing.

By utilizing virtual addresses and/or other redirectors to map to ingest media as provided herein, various advantages that can result in improved performance of a computing system can be realized. For instance, resource usage (e.g., in terms of power consumption, processing cycles, etc.) associated with writing data from ingest media to permanent storage, as well as that associated with accessing file data stored on both the ingest media and permanent storage, can be reduced. Additionally, the amount of write operations performed on a storage disk and/or other data storage devices can be reduced or otherwise optimized, which can in turn extend the operational life of the associated storage devices due to reduced wear or other factors. Other advantages are also possible.

As shown in FIG. 1, system 100 includes two storage locations 10, 30, which correspond to different tiers of storage. In an implementation, storage location 10 corresponds to a storage system that is faster and more expensive relative to storage location 30 but allows for small random writes. Storage location 10 can be utilized as an ingest tier for newly written data, as will be described in further detail below. In some implementations, storage location 10 can include a memory module, e.g., a volatile or non-volatile random access memory (RAM) module. In other implementations, storage location 10 can include a solid state drive (SSD) that utilizes single-level cell (SLC) technology and/or other suitable technologies that enable small scale random writes. In this way, storage location 10 can serve as a cache for incoming data pending the incoming data being written to storage location 30. Other types of storage are also possible.

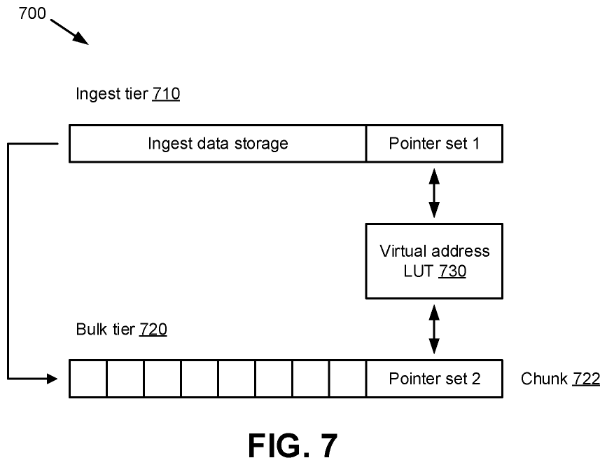

In an implementation, storage location 30 corresponds to a bulk storage system that can store data efficiently but requires writes to be large, contiguous, and aligned. For instance, writes made to storage location 30 can be limited to those of a uniform defined size, e.g., corresponding to a unit or “chunk” of storage location 30. A chunk structure that can be utilized by storage location 30 is described in further detail below with respect to FIG. 7. Storage location 30 can be and/or include high-capacity/low-endurance flash, a shingled magnetic recording (SMR) hard disk drive (HDD), and/or other storage devices that provide high storage capacity but limited write capability. As used herein, storage location 30 is associated with a bulk storage tier.

While only two storage locations 10, 30 associated with an ingest tier and a bulk tier, respectively, are shown in FIG. 1, it is noted that other storage locations and/or tiers could be used in addition to, or in place of, the storage locations shown in FIG. 1. For instance, system 100 could include a third storage tier that includes one or more storage devices that maintain metadata pertaining to data stored at the other storage locations 10, 30. Other storage locations are also possible.

With reference now to the components shown in FIG. 1, the data ingest component 110 can write file data to a first data storage location 10, e.g., associated with an ingest tier. System 100 as shown in FIG. 1 additionally includes an addressing component 120 that can store an address redirector for a block of the file data written by the data ingest component 110 to the first storage location 10. As will be described in further detail below, the address redirector can be a virtual address and/or other indicator that references the first storage location 10 as the location of the data written by the data ingest component 110.

In response to an amount of data written by the data ingest component 110 to storage location 10—which includes data for which the addressing component 120 generates and/or stores an address redirector as described above-being determined to be at least a threshold amount (e.g., a stripe size of a storage drive present at storage location 30 to which data is to be written, and/or other minimum write size associated with storage location 30), the bulk write component 130 of system 100 can facilitate movement of the data written by the data ingest component 110 from storage location 10 to storage location 30. The bulk write component 130 can accomplish this, for example, by writing the data present at storage location 10 to storage location 30. In response to the bulk write component 130 writing the data to storage location 30, the addressing component 120 can alter the address redirector for the block of the file data described above to reference storage location 30 as the location of the block, e.g., in addition to and/or in place of storage location 10.

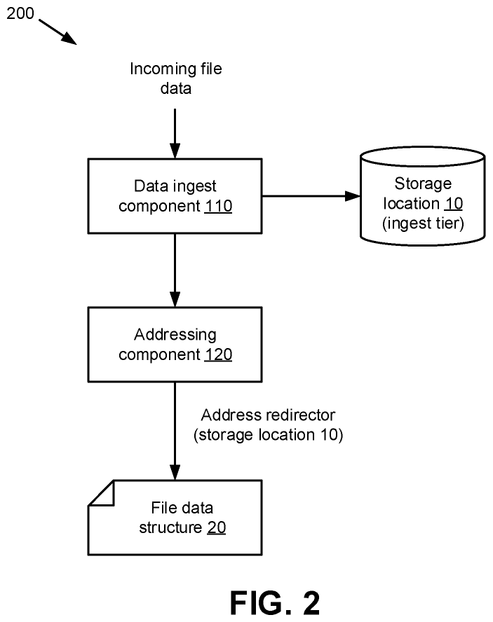

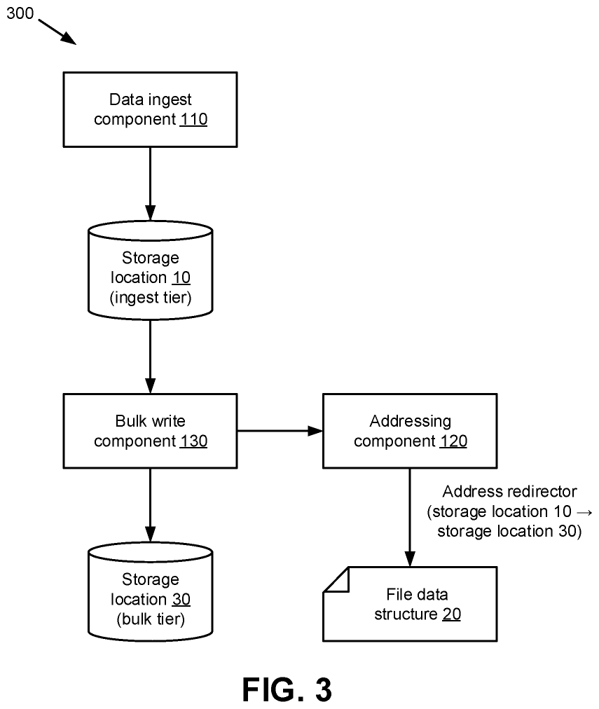

FIG. 2 shows operations that can be performed by the data ingest component 110 and the addressing component 120 of system 100 to store incoming write data to an ingest storage tier, e.g., corresponding to storage location 10. Operations associated with moving data from the ingest tier to a bulk tier, e.g., corresponding to storage location 30, are not shown in FIG. 2 for simplicity of illustration and will be described in further detail below with respect to FIG. 3.

As shown in FIG. 2, the data ingest component 110 can process incoming file data, e.g., data written by a client, application, or other entity associated with system 100 and corresponding to a file stored, or to be stored, by system 100. While FIG. 2 and various implementations herein refer to “file data,” it is noted that other types of data, e.g., data associated with an object stored by an object storage system, could also be processed by system 100 in a similar manner to that described herein.

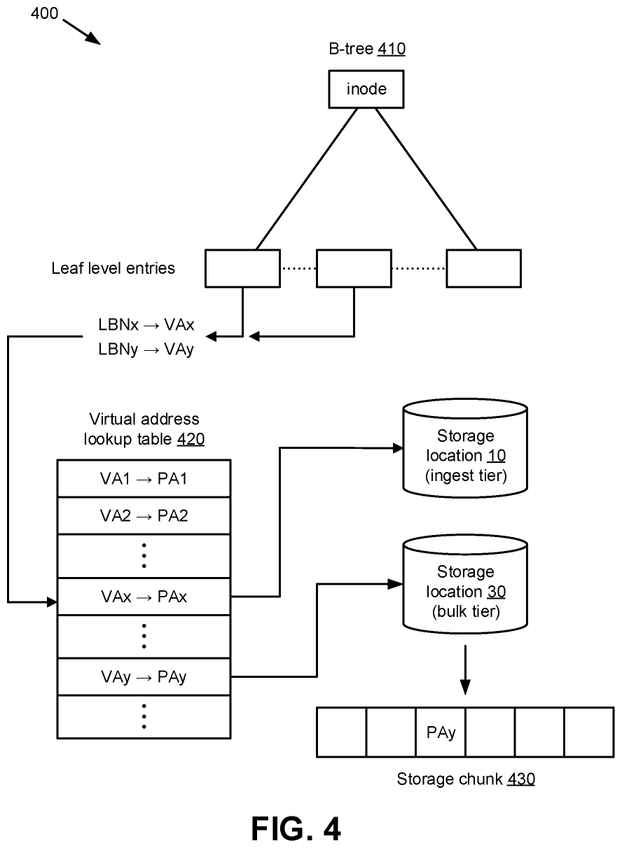

In the event that the incoming file data processed by the data ingest component 110 is smaller than a threshold write size associated with a bulk storage tier, e.g., a chunk size or the like, the data ingest component 110 can temporarily store the data in the ingest tier, e.g., at storage location 10. For instance, the data ingest component 110 can write the data and make the data durable at storage location 10. Once the data ingest component 110 successfully transfers the incoming data to storage location 10, the addressing component 120 can then allocate a new virtual address and/or other address redirector for the block(s) corresponding to the incoming file data. The new virtual address or other address redirector can be configured by the addressing component 120 to indicate that the corresponding data block is located in the ingest tier, e.g., at storage location 10. In doing so, the addressing component 120 can use virtual addresses, and/or other address redirectors, to temporarily tie the ingest tier into the file. In some implementations, the virtual address or other address redirector can be further configured to indicate a location of the data block within the ingest tier, e.g., as will be described in further detail below with respect to FIG. 4.

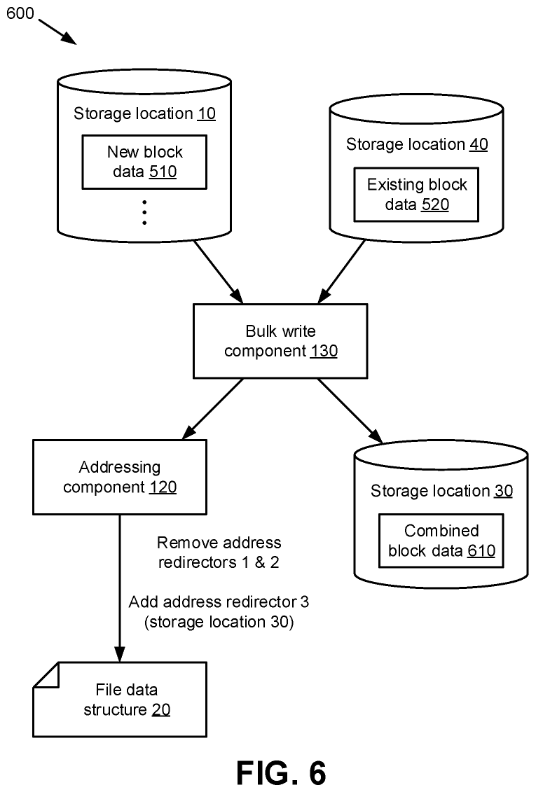

Here, the data block is a new data block, e.g., corresponding to a write that appends to an existing file or creates a new file. Accordingly, the virtual address allocated by the addressing component 120 can be a new virtual address that is added to a data structure 20 maintained for or otherwise corresponding to the file with which the data block is associated. An example of a B-tree that can be utilized to implement the data structure 20 is described in further detail below with respect to FIG. 4. It is noted that other data structure types could also be used. If, instead, the data block at least partially overwrites an existing file, the addressing component 120 can associate the newly allocated virtual address with one or more existing virtual addresses previously allocated for the file, e.g., as will be described in further detail below with respect to FIG. 6.

In an implementation, data written by the data ingest component 110 to storage location 10 can be held at storage location 10 until a total amount of data stored at storage location 10 is at least a threshold amount, e.g., corresponding to a chunk size utilized by a bulk storage tier. With reference now to FIG. 3, further actions that can be performed by system 100 once data of a minimum write size is present at storage location 10. As shown by FIG. 3, the amount of write data that has been stored by the data ingest component 110 to storage location 10, e.g., as described above with respect to FIG. 2, can be determined by the bulk write component 130. Once the amount of data stored at storage location 10 meets the threshold size for a bulk write, the bulk write component 130 can facilitate transferring said data from the ingest storage tier to the bulk storage tier, e.g., from storage location 10 to storage location 30.

In response to the bulk write component 130 moving data to storage location 30, the bulk write component 130 can instruct the addressing component 120 to update a virtual address and/or other address redirector associated with respective blocks of the data moved by the bulk write component. For example, the addressing component 120 can update an address redirector for file data moved from storage location 10 to storage location 30 to reference storage location 30 in addition to, or in place of, storage location 10. Whether the reference to storage location 30 replaces, or is appended to, the previous reference can depend on, e.g., whether the file data is fully moved from storage location 10, e.g., such that the address redirector only references storage location 10 for a given block of data if any part of the data remains at storage location 10.

With reference next to FIG. 4, a diagram 400 depicting addressing operations that can be performed by a computing system in accordance with various implementations described herein is illustrated. Diagram 400 depicts a data structure, here a B-tree 410, that can be utilized to represent blocks associated with a file or other data object stored by a computing system. While a B-tree 410 is shown in FIG. 4 and described in the context of this example, it is noted that other types of data structures could be used. The B-tree 410, which can also be referred to as a file tree in an implementation in which the B-tree 410 relates to a file, can map byte and/or block offset locations in a given file to respective virtual addresses. A separate layer, here a virtual address lookup table 420, can be used to map virtual addresses to physical locations on a given drive and/or volume where the data can be found.

In general, diagram 400 represents various aspects of a file system that can be built on top of system storage, e.g., storage locations 10 and 30. File data can be found within the file system, e.g., by traversing a B-tree 410 corresponding to the file. Additionally, virtual addresses, such as those shown in diagram 400, can be used to allow for garbage collection in the bulk storage tier, e.g., represented here by storage location 30.

The top level of the B-tree 410 shown in diagram 400 includes an inode, which can refer to the file and/or object associated with the B-tree 410. The B-tree 410 can include respective entries on multiple tree levels, ending at a bottom, or leaf, level that contains entries that provide mappings that map logical block numbers associated with the file to a virtual address (VA). In the example shown by diagram 400, a logical block number (LBN) LBNx is mapped to a virtual address VAx in the B-tree 410, and a logical block number LBNy is mapped to a virtual address VAy in the B-tree 410. Virtual addresses VAx and VAy can both be associated with the same leaf level entry of the B-tree 410, e.g., in cases in which data corresponding to a given block is present at multiple locations. Alternatively, virtual addresses VAx and VAy could be associated with separate entries of the B-tree 410.

A virtual address can, in turn, refer to a data structure such as a virtual address lookup table 420. The virtual address lookup table 420 can be a table or other data structure containing entries, shown as lines in diagram 400, corresponding to respective virtual addresses. Each entry of the virtual address lookup table 420 relates a given virtual address to a physical address, which can point to a specific location on a disk, e.g., a disk corresponding to a storage location 10, 30.

In the example shown by diagram 400, virtual addresses can be used to tie the ingest tier (e.g., associated with storage location 10) with the file corresponding to the B-tree 410. For instance, virtual address VAx shown in diagram 400 maps to physical address PAx based on the virtual address lookup table 420, which in turn corresponds to storage location 10. In some implementations, virtual address VAx, and/or other virtual addresses that reference storage location 10, can simply indicate that the underlying data is present at storage location 10 without providing a specific location within storage location 10. In other implementations, a location within storage location 10, e.g., as given by a block offset or the like, could also be provided.

As further shown in diagram 400, virtual address VAy maps to physical address PAy based on the virtual address lookup table 420. The physical address PAy corresponds to a location at storage location 30, e.g., a block or other location within a storage chunk 430 that contains the block corresponding to LBNx.

In the example shown by diagram 400, virtual addresses allocated for a given file can be of a similar format regardless of whether a given virtual address ultimately maps to storage location 10 or storage location 30. To distinguish between storage tiers, respective entries of the virtual address lookup table 420 can map to physical addresses that include a drive or volume identifier, which can also serve as a tier identifier since the drives and/or volumes used for storage locations 10 and 30 will generally be mutually exclusive due to the different properties of ingest and bulk storage.

In an implementation, the storage chunk 430 can be a partition of storage location 30 and can contain one or more blocks into which data can be written. In a system that is optimized for append-only writing (high-capacity/low endurance flash, a shingled magnetic recording (SMR) hard disk drive (HDD), etc.), the physical space can be partitioned into multiple chunks of manageable size, where each chunk can be filled sequentially. An example sequential write that can be made to storage location 30 is described in further detail below with respect to FIG. 7.

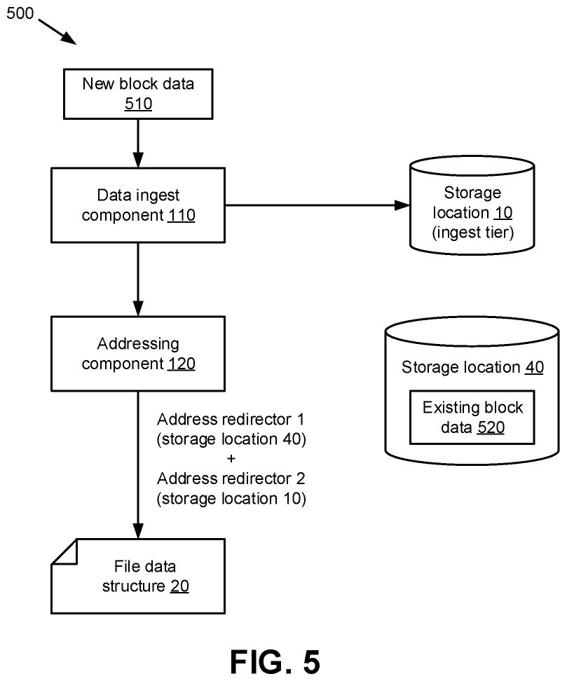

As described above, e.g., with respect to FIG. 2, when a write for a file is performed, and that write is not sufficiently large to be directly stored on the bulk storage tier (e.g., storage location 30), and an application or other entity has indicated that the write is to be stored on permanent storage immediately, the write can be stored in the ingest tier (e.g., storage location 10). Additionally, new virtual addresses can be allocated for any block(s) that are affected by the write. These virtual addresses can then be added to the B-tree 410 of the affected file. If the write is fully overwriting an existing block, or is adding a net-new block to the file, a simple reference to the ingest tier location (e.g., storage location 10) can be stored in the virtual address, e.g., as described above. Alternatively, if the write is only partially overwriting an existing block, a reference to the previous virtual address can be stored in the new virtual address, e.g., as will be described in further detail below with respect to FIG. 5.

Turning next to FIG. 5, a block diagram of another system 500 that facilitates efficient ingest tier references via virtual addresses in accordance with various implementations described herein is illustrated. More particularly, FIG. 5 illustrates operations that can be performed for a write that only partially supersedes a previous write, i.e., a write operation that overwrites less than all of an existing block of data. Here, the data ingest component 110 receives new block data 510, which can correspond to a file or other data object. Additionally, the new block data 510 partially overwrites existing block data 520 previously stored by system 500 to storage location 40, which can be associated with either the ingest storage tier or the bulk storage tier as described above.

In response to the data ingest component 110 successfully writing the new block data 510 to storage location 10, the addressing component 120 can determine whether, and/or to what extent, the new block data 510 supersedes the existing block data 520 at storage location 40. The addressing component 120 can do so by consulting a B-tree and/or other data structure 20 associated with a file or other data object corresponding to the new block data 510, e.g., which can be maintained for the file and/or other object as described above with respect to FIG. 4.

In the example shown by FIG. 5, the addressing component 120 determines that the new block data 510 overwrites some, but not all, of the existing block data 520. As a result, the addressing component 120 can keep a reference to an address redirector for the existing block data 520 in the address redirector allocated by the addressing component 120 for the new block data 510. For instance, the addressing component 120 can append a reference to a virtual address for the existing block data 520 to a virtual address for the new block data 510. Other techniques for storing a reference to a previous virtual address with a new virtual address are also possible.

With reference next to system 600 illustrated by FIG. 6, further operations that can be performed once sufficient data has accumulated at storage location 10 for a bulk write are illustrated. Storage location 10 as shown in FIG. 6 includes new block data 510 that at least partially overwrites existing block data at another storage location 40, e.g., as described above with respect to FIG. 5. While not shown in FIG. 6, storage location 10 can also include additional write data, which can be associated with a same file or data object as the new block data 510 and/or other files or data objects.

To initiate a flush operation as shown in FIG. 6, the bulk write component 130 can determine if any data stored at storage location 10 partially overwrites existing data, e.g., by determining whether any of the virtual addresses allocated to the data stored at storage location 10 contain references to another virtual address. Here, the new block data 510 partially overwrites the existing block data 520, and in response the bulk write component 130 can read the existing block data 520 (e.g., by referencing its virtual address), combine the new block data 510 with any non-superseded portions of the existing block data 520 to create combined block data 610, and flush the combined block data 610 to the bulk storage tier, here represented by storage location 30.

Once the bulk write component 130 successfully writes the combined block data 610 to storage location 30, the addressing component 120 can decrement a reference count associated with a virtual address and/or other address redirector for the existing block data 520 present at storage location 30. If this reference count is greater than zero after decrementing, the addressing component 120 can preserve the virtual address and/or other address redirector for the existing block data 520, e.g., as a nonzero reference count indicates that other files are still using the existing block data 520. Otherwise, if the reference count becomes zero, the addressing component 120 can also deallocate the virtual address and/or other address redirector for the existing block data 520.

As further shown in FIG. 6, the addressing component 120 can additionally update the virtual address, or other address redirector, for the new block data 510 to reference the location of the combined block data 610 within storage location 30, e.g., instead of the location of the new block data 510 within storage location 10. Because modifying a virtual address in this manner can be performed by simply changing an entry of an associated virtual address lookup table, the addressing component 120 can facilitate updating the address of the combined block data 610 without modifying the data structure 20 associated with the underlying file and incurring the associated overhead.

Referring now to FIG. 7, diagram 700 depicts an example transfer of data, e.g., by a bulk write component 130 as described above, from an ingest storage tier 710 to a bulk storage tier 720 in accordance with various implementations described herein. As shown in diagram 700, data can be written to the ingest tier 710, e.g., pending the amount of data stored by the ingest tier 710 reaching a threshold size for flushing the data to the bulk tier 720. The ingest tier 710 shown in diagram 700 can further include a pointer set that refer to the virtual addresses, or other address redirectors, that are responsible for the data written to the ingest tier 710. These address redirectors can be maintained, e.g., by a virtual address lookup table 730, which can be similar in structure and functionality to the virtual address lookup table 420 described above with respect to FIG. 4.

Once enough data has accumulated in the ingest tier 710 to fill a full chunk 722 of the bulk storage tier 720, the data in the ingest tier 710 can be flushed to the bulk storage tier 720, and any affected virtual addresses and/or other address redirectors can be updated. It is noted that in some cases data from a previous virtual address may be read before the flush operation, e.g., in the case of a partial overwrite as described above with respect to FIG. 6. Additionally, respective pointers can be written to the chunk 722, and/or a structure associated with the chunk such as a chunk directory, to update the location of the blocks forming the new chunk 722 in the virtual address lookup table 730. Modifying the virtual addresses and/or other address redirectors can completely remove the need for touching affected files during ingest tier flushing, which in turn can disentangle the insert and flush processing.

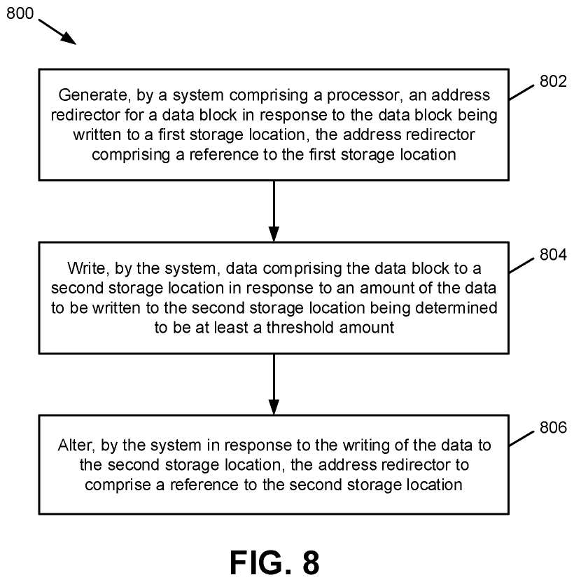

Turning to FIG. 8, a flow diagram of a method 800 that facilitates efficient ingest tier references via virtual addresses is illustrated. At 802, a system comprising a processor can generate (e.g., by an addressing component 120) an address redirector (e.g., a virtual address) for a data block in response to the data block being written (e.g., by a data ingest component 110) to a first storage location (e.g., storage location 10 and/or an ingest tier). The address generator generated at 802 can include a reference to the first storage location.

At 804, the system can write (e.g., by a bulk write component 130) data comprising the data block to a second storage location (e.g., storage location 30 and/or a bulk tier) in response to an amount of the data to be written to the second storage location being determined to be at least a threshold amount.

At 806, in response to the writing of the data to the second storage location at 804, the system can alter (e.g., by the addressing component 120) the address redirector generated at 802 to comprise a reference to the second storage location to which the data was written at 804.

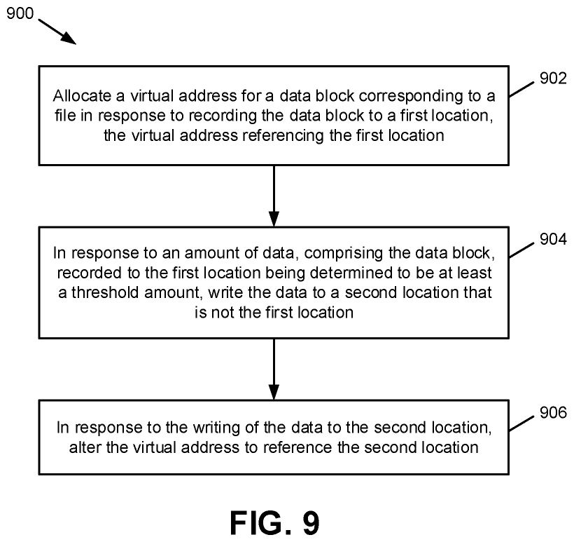

Referring next to FIG. 9, a flow diagram of a method 900 that can be performed by a processor, e.g., based on machine-executable instructions stored on a non-transitory machine-readable medium, is illustrated. An example of a computer architecture, including a processor and non-transitory media, that can be utilized to implement method 900 is described below with respect to FIG. 10.

Method 900 can begin at 902, in which the processor can allocate a virtual address for a data block corresponding to a file in response to recording the data block to a first location, where the virtual address allocated at 902 references the first location.

At 904, the processor can, in response to an amount of data, comprising the data block, recorded to the first location being determined to be at least a threshold amount, write the data to a second location that is not the first location.

At 906, the processor can, in response to the writing of the data to the second location at 904, alter the virtual address allocated at 902 to reference the second location.

FIGS. 8-9 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD), a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
at least one memory that stores instructions; and
at least one processor that executes the instructions stored in the memory, wherein the instructions cause the at least one processor to:
write file data, corresponding to a file, to a first data storage location, wherein the first data storage location is a temporary physical storage location;
allocate an address redirector for a block of the file data, the address redirector referencing the first data storage location;
in response to allocating the address redirector, map the address redirector to a logical block number associated with the block of the file data in a data structure associated with the file;
in response to an amount of write data, comprising the file data, being determined to be at least a threshold amount, write the write data to a second data storage location that is not the first data storage location, wherein the second data storage location is a permanent physical storage location; and
alter the address redirector to reference the second data storage location in response to the write data being written to the second data storage location.

2. (canceled)

3. The system of claim 1, wherein the data structure is a B-tree.

4. The system of claim 1, wherein the file data is first file data, wherein the file is a first file, and wherein the write data further comprises second file data corresponding to a second file that is not the first file.

5. The system of claim 1, wherein the block of the file data is a first block that overwrites at least a portion of a second block stored at a third data storage location.

6. The system of claim 5, wherein the address redirector is a first address redirector, wherein the first block of the file data overwrites less than all of the second block of the file data, and wherein the instructions further cause the at least one processor to store a reference to a second address redirector for the second block in the first address redirector.

7. The system of claim 6, wherein the instructions further cause the at least one processor to:
combine the first block with a non-overwritten portion of the second block, resulting in combined write data; and
write the combined write data to the second data storage location.

8. The system of claim 7, wherein the instructions further cause the at least one processor to:
alter the second address redirector to reference the second data storage location in response to the combined write data being written to the second data storage location.

9. The system of claim 1, wherein the address redirector is a virtual address.

10. The system of claim 1, wherein the first data storage location is associated with a memory module, and wherein the second data storage location is associated with a storage drive.

11. A method, comprising:
generating, by a system comprising a processor, an address redirector for a data block associated with a file in response to the data block being written to a first storage location, the address redirector comprising a reference to the first storage location, wherein the first storage location is a temporary physical storage location;
in response to generating the address redirector, mapping, by the system, the address redirector to a logical block number associated with the data block in a file structure maintained for the file;
writing, by the system, data comprising the data block to a second storage location in response to an amount of the data to be written to the second storage location being determined to be at least a threshold amount, wherein the second data storage location is a permanent physical storage location; and
altering, by the system in response to the writing of the data to the second storage location, the address redirector to comprise a reference to the second storage location.

12. (canceled)

13. The method of claim 11, wherein the data block is a first data block that at least partially supersedes a second data block stored at a third storage location.

14. The method of claim 13, wherein the address redirector is a first address redirector, wherein the first data block supersedes less than all of the first data block, and wherein the method further comprises:
appending, by the system, a reference to a second address redirector for the second data block to the first address redirector.

15. The method of claim 14, wherein the writing of the data to the second storage location comprises combining the first data block with a non-superseded portion of the second data block, resulting in combined data, and writing the combined data to the second storage location, and wherein the method further comprises:
altering, by the system in response to the writing of the combined data, the second address redirector to reference the second storage location instead of the third storage location.

16. The method of claim 11, wherein the second storage location is associated with a storage drive, and wherein the threshold amount corresponds to a stripe size of the storage drive.

17. A non-transitory machine-readable medium comprising computer executable instructions that, when executed by a processor, facilitate performance of operations, the operations comprising:
allocating a virtual address for a data block corresponding to a file in response to recording the data block to a first location, wherein the virtual address references the first location, and wherein the first location is a temporary physical storage location;
in response to allocating the virtual address, mapping the virtual address to a logical block number associated with the data block in a data structure associated with the file;
in response to an amount of data, comprising the data block, recorded to the first location being determined to be at least a threshold amount, writing the data to a second location that is not the first location, wherein the second location is a permanent physical storage location; and
in response to the writing of the data to the second location, altering the virtual address to reference the second location.

18. The non-transitory machine-readable medium of claim 17, wherein
the data structure associated with the file is a B-tree.

19. The non-transitory machine-readable medium of claim 17, wherein the virtual address is a first virtual address, wherein the data block is a first data block that overwrites less than all of a second data block, corresponding to the file and stored at a third location, and wherein the operations further comprise:
inserting a reference to a second virtual address for the second data block into the first virtual address.

20. The non-transitory machine-readable medium of claim 19, wherein the operations further comprise:
combining the first data block with a non-overwritten portion of the second data block, resulting in a combined data block, wherein the writing of the data comprises writing the combined data block to the second location; and
in response to the writing of the combined data block, altering the second virtual address to reference the second location instead of the third location.

21. The system of claim 1, wherein:
the data structure is a first data structure,
mapping of the address redirector to the logical block number comprises creating an entry in a second data structure that is different from the first data structure, the entry in the second data structure comprising the virtual address and the first data storage location, and
altering of the address redirector comprises adding the second data storage location to the entry in the second data structure.

22. The system of claim 21, wherein:
the mapping of the address redirector to the logical block number further comprises adding a first volume identifier to the entry in the second data structure, the first volume identifier corresponding to the first data storage location, and
the altering of the address redirector further comprises adding a second volume identifier to the entry in the second data structure, the second volume identifier corresponding to the second data storage location, without modifying any portion of the first data structure.
